(19) United States
(12) Patent Application Publication
(10) Pub. No.: US 2022/0214219 A1
(43) Pub. Date: Jul. 7, 2022

(54) Metasurface Mask for Full-Stokes Division of Focal Plane Polarization of Cameras

(71) Applicant: California Institute of Technology, Pasadena, CA (US)

(72) Inventors: Andrei FARAON, Pasadena, CA (US); Seyedeh Mahsa KAMALI, Pasadena, CA (US); Amir ARBABI, Sunderland, MA (US); Ehsan ARBABI, Pasadena, CA (US)

(21) Appl. No.: 16/777,491

(22) Filed: Jan. 30, 2020

Related U.S. Application Data
(60) Provisional application No. 62/802,143, filed on Feb. 6, 2019.

(51) Int. Cl. G01J 4/04; G01J 3/02

(52) U.S. Cl. CPC G01J 4/04; G01J 3/0229; G01J 3/0224

(57) ABSTRACT

Metasurfaces for polarimetric imaging are disclosed. The described devices are built to split and focus light to various pixels on an image sensor for different polarization bases. This allows for complete characterization of polarization by measuring the four Stokes parameters over the area of each superpixel, which corresponds to the area of the pixels on the image sensor.

### CROSS REFERENCE TO RELATED APPLICATIONS

The present application claims priority to U.S. Provisional Patent Application No. 62/802,143 filed on Feb. 6, 2019 and may be related to U.S. Pat. No. 9,739,918 B2 issued on Aug. 22, 2017, titled “Simultaneous Polarization and Wavefront Control Using a Planar Device”, both disclosures of which are incorporated herein by reference in their entirety.

### STATEMENT OF GOVERNMENT GRANT

This invention was made with government support under Grant No. HR0011-17-2-0035 awarded by DARPA. The government has certain rights in the invention.

### FIELD

The present disclosure is related to polarimetric imaging, and more particularly to devices including metasurface masks for full-stokes division of focal plane polarization of cameras.

### BACKGROUND

Polarization is a degree of freedom of light carrying important information about the light source, the surfaces that the light has been reflected off, or the materials that the light has passed through. Such information is usually absent in intensity and spectral content. The state of polarization is typically described by the four Stokes parameters.

Imaging polarimetry is the process of determining the polarization state of light, either partially or fully, over an extended scene. It has found several applications in various fields of science from remote sensing to biology. Among different devices for imaging polarimetry, division of focal plane polarization cameras (DoFP-PCs) are more compact, less complicated, and less expensive. In recent years, there have been significant improvements in the performance of DoFP-PCs. However, an unresolved limitation is that they can only partially measure the state of polarization, as the degree of circular polarization and helicity are two important properties of polarization that DoFP-PCs conventionally miss. This means that circularly polarized and unpolarized light appear the same for the current DoFP-PCs.

Generally, polarimetric imaging techniques can be categorized in division of amplitude, division of aperture, and division of focal plane. All of these methods are based on measuring the intensity in different polarization bases and using them to estimate the full Stokes vector (i.e. a vector containing information about all four Stokes parameters) or part of it. Among various systems, DoFP-PCs are less expensive, more compact, and require less complicated optics. In addition, they require much less effort for registering images of different polarizations as the registration is automatically achieved in the fabrication of the polar-ization sensitive image sensor. The advances in micro/nano-fabrication have increased the quality of DoFP-PCs and reduced their fabrication costs, making them commercially available. DoFP-PCs either use a birefringent crystal to split polarizations, or thin-film or wire-grid polarization filters.

The main problem with all the above-mentioned methods is that they only work for linear polarization bases, and therefore, as already noted above, cannot measure the degree of circular polarization and helicity. Although form-birefringent quarter waveplates can be integrated with linear polarizers to make circular polarization filters in the mid-IR, their performance as DoFP-PCs with full-Stokes characterization capability has not been disclosed. A secondary issue with current DoFP-PCs is that they all have a theoretical efficiency limit of 50% due to using polarization filters, or spatially blocking half of the aperture.

### SUMMARY

The disclosed methods and devices address the described challenges and provide practical solutions to the above-mentioned problems.

According to a first aspect of the disclosure, a metasurface-based electromagnetic wave splitting device is provided, comprising: a substrate, and an array of nano-posts on the substrate, the nano-posts having C₂-symmetric shapes; wherein: the nano-posts are configured to split an incident electromagnetic wave into a plurality of polarization bases and to focus the split incident electromagnetic wave onto a plurality of target areas according to the plurality of polarization bases.

According to a second aspect of the disclosure, an imaging method is disclosed, comprising: providing an array of nano-posts resting on a substrate; providing an image sensor including a superpixel, and applying light to the array of nano-posts, wherein dimensions of the nano-posts, orientations of the nano-posts, and distances between adjacent nano-posts are configured to: scatter the light off the array of nano-posts; split the light into a plurality of polarization bases, and focus the light onto pixels of the superpixel according to the plurality of polarization bases.

Further aspects of the disclosure are provided in the description, drawings and claims of the present application.

### DESCRIPTION OF THE DRAWINGS

FIG. 1 shows a prior art setup used for polarimetry.

FIG. 2 shows an exemplary functionality of a metasurface according to an embodiment of the present disclosure.

FIGS. 3A-3B show an exemplary metasurface in accordance with embodiments of the present disclosure.

FIG. 4 shows an exemplary arrangement of a superpixel of an image sensor according to embodiments of the present disclosure.

FIG. 5A shows an exemplary nano-post resting on a substrate according to embodiments of the present disclosure.

FIG. 5B shows an exemplary rotated nano-post according to embodiments of the present disclosure

FIG. 6 shows phase vs. dimensions graphs used for finding the in-plane dimensions of a nano-post in accordance with embodiments of the present disclosure

FIG. 7 shows phase profiles for a metasurface that performs both polarization beam splitting and focusing at two orthogonal polarizations according to embodiments of the present disclosure.

FIG. 8 shows exemplary superpixel characterization results according to the teachings of the present disclosure.

FIG. 9 shows exemplary polarimetric imaging results according to the teachings of the present disclosure.

### DETAILED DESCRIPTION

Throughout the present disclosure, the term “superpixel” is used to refer to a combination of several pixels of an image sensor. For example, three pairs of adjacent pixels represent a “superpixel”.

Throughout the present disclosure, the term “C₂ symmetry axis” of an object is used to refer to an axis around which a rotation by 180° results in an object indistinguishable from the original. This object is referred to as an object having a C₂-symmetric shape.

Throughout the present disclosure the terms “nano-post” or “nano-scatterers” are used to refer to a miniaturized scatterer object having dimensions that are substantially comparable with the operational wavelength of the device implementing such a scatterer.

Optical dielectric metasurfaces are a category of micro-fabricated diffractive optical elements comprised of dielectric nano-scatterers on a surface, judiciously designed to control the wavefront. They have enabled high-efficiency phase and polarization control with large gradients. In addition, their compatibility with conventional microfabrication techniques allows for their integration into optical metasystems.

Metasurfaces have previously been used for polarimetry, but not polarimetric imaging. As disclosed in the above-mentioned U.S. Pat. No. 9,739,918 B2, a notable capability of high contrast dielectric metasurfaces is the simultaneous control of polarization and phase. Such concept is adopted by the teachings of the present disclosure to build metasurface masks for DoFP-PCs with the ability to fully measure the Stokes parameters, including the degree of circular polarization and helicity. Instead of polarization filtering, the disclosed methods and devices are based on splitting and focusing light in, for example, three different polarization bases. Such an approach makes the full-Stokes characterization of the state of polarization possible while overcoming the 50% theoretical efficiency limit of the polarization-filter-based DoFP-PCs as described previously.

There are several representations for polarization of light. Among them, the Stokes vector formalism has some conceptual and experimental advantages since it can be used to represent light with various degrees of polarization, and can be directly determined by measuring the power in certain polarization bases. Therefore, most imaging polarimetry systems determine the Stokes vector, which is usually defined as S=(1/I)[I, (Ix−Iy), (I45−I-45), (IR−IL)], where I is the total intensity, Ix, Iy, I45, and I-45 are the intensity of light in linear polarization bases along the x, y, +45-degree, and −45-degree directions, respectively. IR and IL denote the intensities of the right-hand and left-hand circularly polarized light. To fully characterize the state of polarization, all these intensities should be determined.

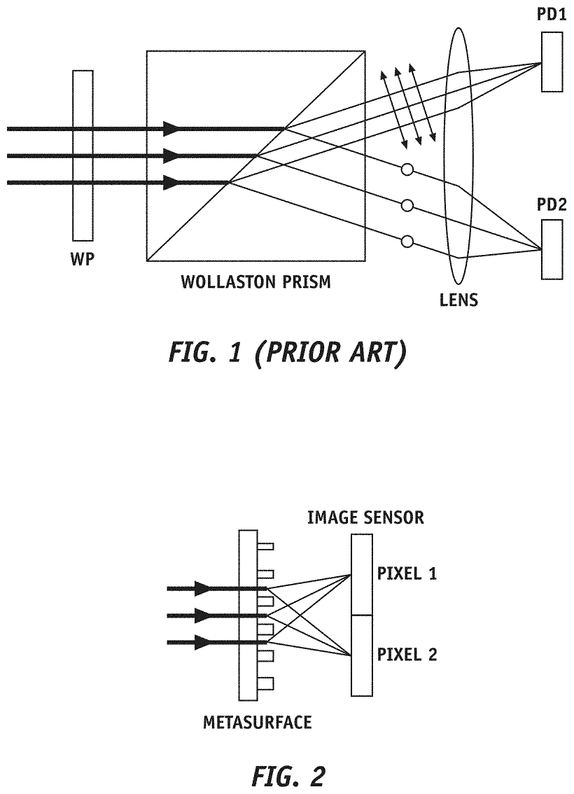

FIG. 1 shows a prior art setup used to measure the full Stokes vector. A waveplate (half or quarter), followed by a Wollaston prism and a lens that focuses the beams on photodetectors. Using no waveplate, a half-waveplate (HWP), and a quarter-waveplate (QWP) along with the prism, one can measure the four Stokes parameters used to fully characterize the polarization state of light.

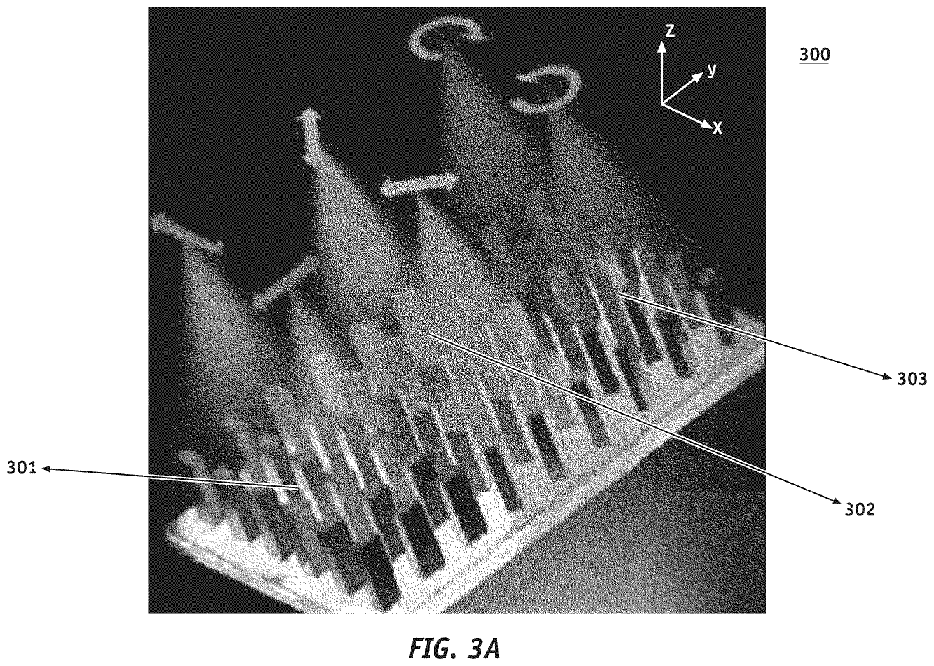

As described in the above-mentioned U.S. Pat. No. 9,739,918 B2, an optical metasurface with the ability to fully control phase and polarization of light can perform the same task over a substantially smaller volume and without changing any optical components. The metasurface can split any two orthogonal states of polarization and simultaneously focus them to different points with high efficiency and on a micro-scale. This is schematically shown in FIG. 2, wherein the incident light is split into two pixels (Pixel 1, Pixel 2) of an image sensor.

According to an embodiment of the present disclosure, the metasurface of FIG. 2 may be directly integrated on an image sensor to provide a polarization camera. To fully measure the Stokes parameters, the projection of the input light on three different polarization basis sets should be measured.

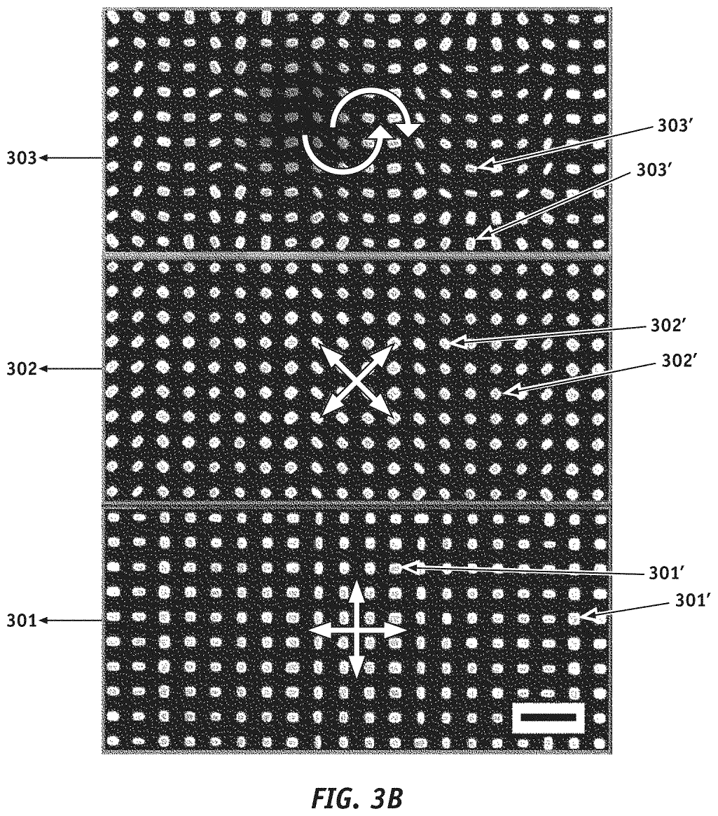

FIG. 3A shows an exemplary metasurface (300) according to embodiments of the present disclosure. As later described in additional detail, the metasurface (300) essentially operates as a polarization beam-splitter (PBS). Metasurface (300) comprises three regions (301, 302, 303) corresponding to three different polarization basis sets. Each basis comprises two polarization states. An exemplary choice of basis may be horizontal/vertical (H/V), ±45° linear, and right-hand-circular/left-hand-circular (RHCP/LHCP) that can be used to directly measure the Stokes parameters. Other choices of basis may also be envisaged in accordance with the teachings of the present disclosure. Continuing with the same example above, the metasurface (300) may be placed above a superpixel of an image sensor, wherein the superpixel comprises 3 sets of pixels, each corresponding to a region of the PBS (300).

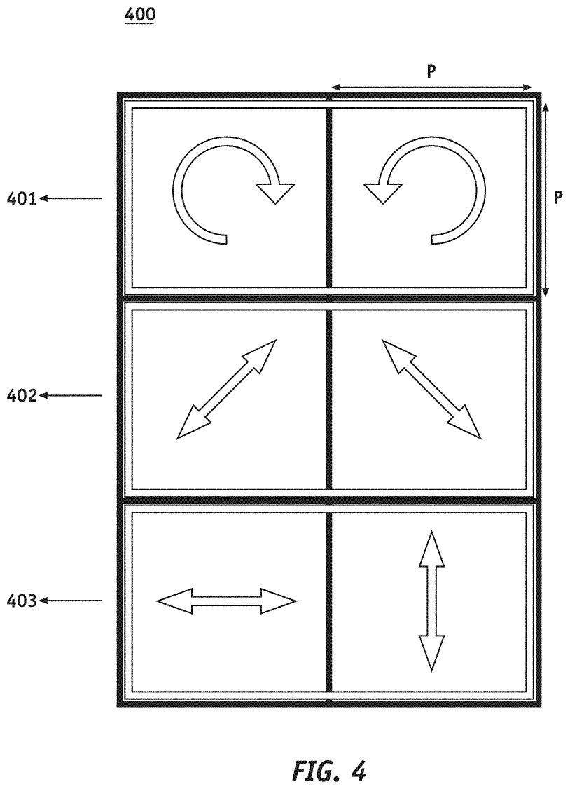

FIG. 4 presents an illustration of a superpixel (400) with three sets of pixel (401, 402, 403). As shown, pixel set (401) comprises two pixels corresponding to horizontal/vertical states of polarization, pixel set (402) comprises two pixels corresponding to ±45° linear polarization states, and pixel set (403) comprises two pixels corresponding to RHCP/LHCP polarization states.

With reference to FIGS. 3A, 3B and 4, the light incident on the metasurface (300) is decomposed into the six pixels of superpixel (400). As such, the six polarization states of the light are each measured through corresponding pixels. In other words, each pixel of the image sensor superpixel (400) may be used to measure the power in a single polarization state, and therefore, the full polarization state of the electromagnetic wave can now be tracked back through such measurements, and using Stokes vector formalism. In what follows, exemplary embodiments according to the present disclosure will be used to further clarify the above-mentioned concept. Moreover, some of the concepts disclosed in the above-incorporated U.S. Pat. No. 9,739,918 B2 are briefly touched upon for the sake of overall clarity and an easier read.

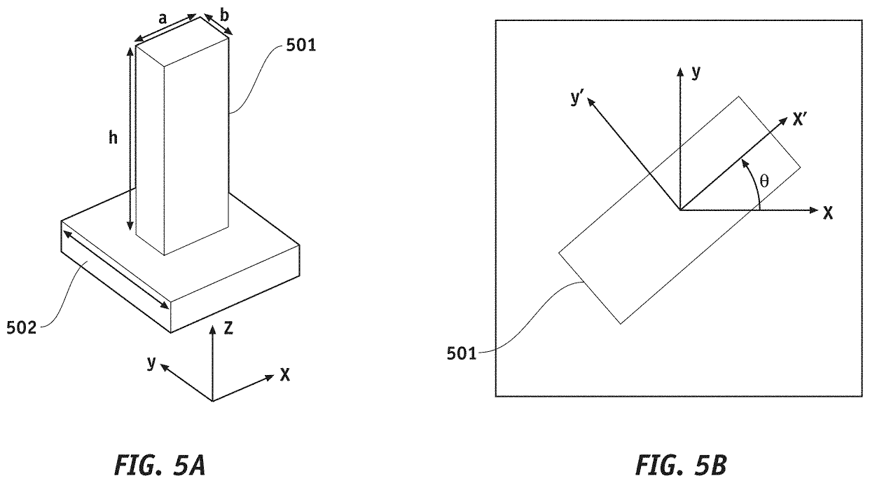

FIG. 3B shows a top view of the metasurface (300) of FIG. 3A according to the teachings of the present disclosure. Each of the regions (301, 302, 303) comprises a plurality of nano-posts (301′, 302′, 303′). FIG. 5A shows a nano-post (501) with a rectangular cross section resting on a substrate (502). The refractive index of the nano-post (501) may preferably be higher than the refractive index of the substrate. The nano-post (501) may be made of, for example, α-Si and the substrate (502) may be a glass substrate, although other materials may be used to build both the nano-post (501) and the substrate (502). In accordance with embodiments of the present disclosure nano-post (501) may have a C₂-symmetric shape such as ellipsoidal or rhomboidal.

With reference to FIGS. 3B and 5A, the term “lattice constants” is referred to the horizontal and the vertical distance of a nano-post from the adjacent nano-posts. By proper choice of the dimensions of each of the nano-posts (301′, 302′, 303′), their orientations, and the lattice constant (e.g., 650 nm and 480 nm, respectively at a wavelength of 850 nm) the nano-posts (301′, 302′, 303′) can provide full and independent 2π phase control over x and y-polarized light where x and y are aligned with the axes of the nano-posts (301′, 302′, 303′). In accordance with the teachings of the present disclosure, the lattice constants may be within ½ wavelength+/−30%.

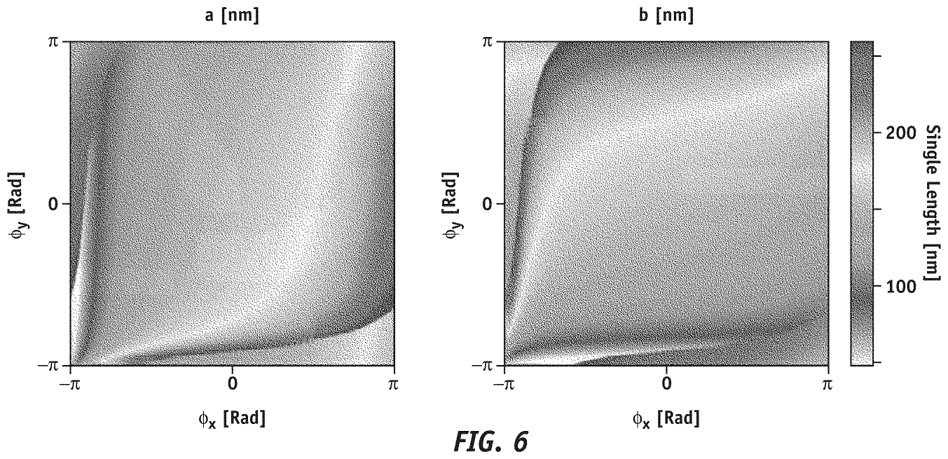

FIG. 6 shows phase vs. dimensions graphs used for finding the in-plane dimensions of a nano-post that provides a required pair of transmission phases for the x and y-polarized light. Using such graphs, the nano-post dimensions required to provide a specific pair of phase values, φₓ and φ_{y} can be calculated. This allows to build a metasurface that controls x and y-polarized light independently. With some generalization, the same may be applied to any two orthogonal linear polarization using nano-posts that are rotated around their optical axis with the correct angle to match the new linear polarizations.

FIG. 5B shows nano-post (501) rotated by an angle (θ) around the x and y axis thus generating the new axes x′ and y′. This can be done on a nano-post by nano-post manner, where the polarization basis is different for each nano-post. This property allows to build the metasurface (300) of FIG. 3 for polarization bases of interest. In order to further clarify the above-mentioned approach of building the metasurface (300) of FIGS. 3A and 3B, and for an overall easier read, in what follows, the concepts disclosed in the above-incorporated application are briefly reiterated.

The operation of a nano-post can be modeled by a Jones matrix related the input and output electric fields (i.e. E^{out}=TEⁱⁿ). For the rotated nano-post (401) shown in FIG. 4B, the Jones matrix can be written as:

$$T = [ \begin{matrix}{T}_{xx} & {T}_{xy} \\ {T}_{yx} & {T}_{yy}\end{matrix} ] = R ( θ ) [ \begin{matrix}{e}^{i {φ}_{x ′}} & 0 \\ 0 & {e}^{i {φ}_{y ′}}\end{matrix} ] R ( - θ ) \qquad ( 1 )$$

where R(θ) denotes the rotation matrix by the angle θ as shown in FIG. 5B. The right hand side of equation (1) is a unitary and symmetric matrix, i.e. the elements of the Jones matrix are related to each other using these conditions. The following relation between the output and input field can therefore be obtained:

$$[ \begin{matrix}{E}_{x}^{out *} & {E}_{y}^{out *} \\ {E}_{x}^{in} & {E}_{y}^{in}\end{matrix} ] [ \begin{matrix}{T}_{xx} \\ {T}_{yx}\end{matrix} ] = [ \begin{matrix}{E}_{x}^{in *} \\ {E}_{x}^{out}\end{matrix} ] \qquad ( 2 )$$

where * is used to show complex conjugation. Based on equation (2), the Jones matrix to transform any input field with a given phase and polarization to any desired output field with a different phase and polarization can be calculated, and therefore a complete and independent phase and polarization is made possible through such equation.

In the case where the determinant of the matrix on the left hand side of equation (2) is zero, the following can be obtained:

$$[ \begin{matrix}{E}_{1 , x}^{in} & {E}_{1 , y}^{in} \\ {E}_{2 , x}^{in} & {E}_{2 , y}^{in}\end{matrix} ] [ \begin{matrix}{T}_{xx} \\ {T}_{yx}\end{matrix} ] = [ \begin{matrix}{E}_{1 , x}^{out} \\ {E}_{2 , x}^{out}\end{matrix} ] = [ \begin{matrix}{e}^{i {φ}_{1}} & {E}_{1 , x}^{in *} \\ {e}^{i {φ}_{2}} & {E}_{2 , x}^{in *}\end{matrix} ] \qquad ( 3 )$$

wherein φ₁ and φ₂ represent the phase relation between the input and output polarizations. Equation (3) essentially indicates that given any two orthogonal input polarizations (E₁ⁱⁿ,E₂ⁱⁿ), their phases can be independently controlled using the Jones matrix given by equation (3).

When the Jones matrix is calculated from equation (3) (or equation (2) depending on the functions), the two phases (φ_{x′},φ_{y′}) and the rotation angle (θ) can be calculated from equation (1) by finding the eigenvalues and eigenvectors of the Jones matrix. This can be repeated independently for each nano-post, meaning that the polarization basis can be changed from one nano-post to the next.

In order to fabricate metasurface (300) of FIGS. 3A and 3B in accordance with the embodiments of the present disclosure, and based on the concept described above, the polarization bases are selected. By way of example and not of limitation, three different sets of H/V, ±45°, and RHCP/LHCP may be selected. Then the required phase profiles are determined to split each two orthogonal polarization and focus them to the centers of adjacent pixels of the superpixel of the image sensor as shown in FIG. 4.

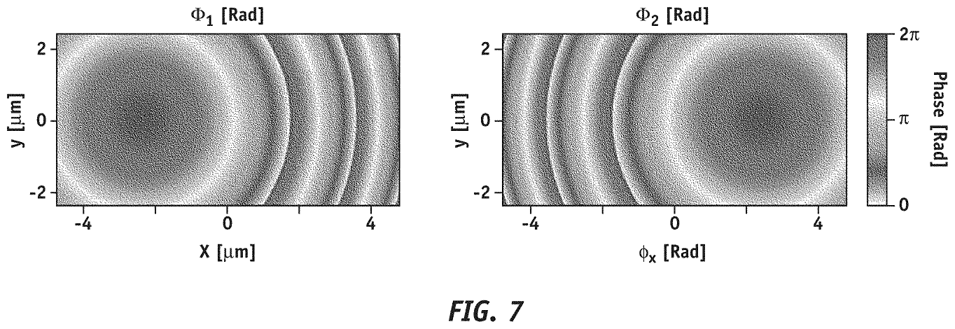

FIG. 7 shows the required profiles for a metasurface that does both polarization beam splitting and focusing at two orthogonal polarizations. These can be any set of orthogonal polarizations, linear or elliptical. The focal distance for these phase profiles is 9.6 μm, equal to the width of the superpixel in the x direction. The lateral positions of the focal spots are x=±2.4 μm and y=0. Since each polarization basis covers two image sensor pixels, the phases are defined over the area of two pixels. In addition, the calculated phases are the same for the three different polarization bases, and therefore only one basis set is shown in FIG. 7. Using these phases and knowing the polarization basis at each point, we calculated the rotation angles and nano-post dimensions from equations (3) and (1) along with FIG. 6).

According to the teachings of the present disclosure, the same design principle and concept described above can also be applied to electromagnetic waves of any frequency range given the use of appropriate material systems and scaling the designs accordingly. For example, the same principles can be used to design division of focal plane polarization cameras in the visible range using silicon nitride, titanium oxide, or crystalline silicon nano-posts, in the near and mid IR ranges using amorphous or crystalline silicon, and in various ranges of far IR using different dielectric or metallic materials

A metasurface was fabricated based on the concepts detailed above. 650-nm-thick layer of α-Si was deposited on a 500-μm-thick fused silica wafer in a plasma enhanced chemical vapor deposition process. The metasurface pattern was defined using electron-beam lithography, and transferred to the α-Si layer through a lift-off process (to make a hard etch-mask) followed by dry etching.

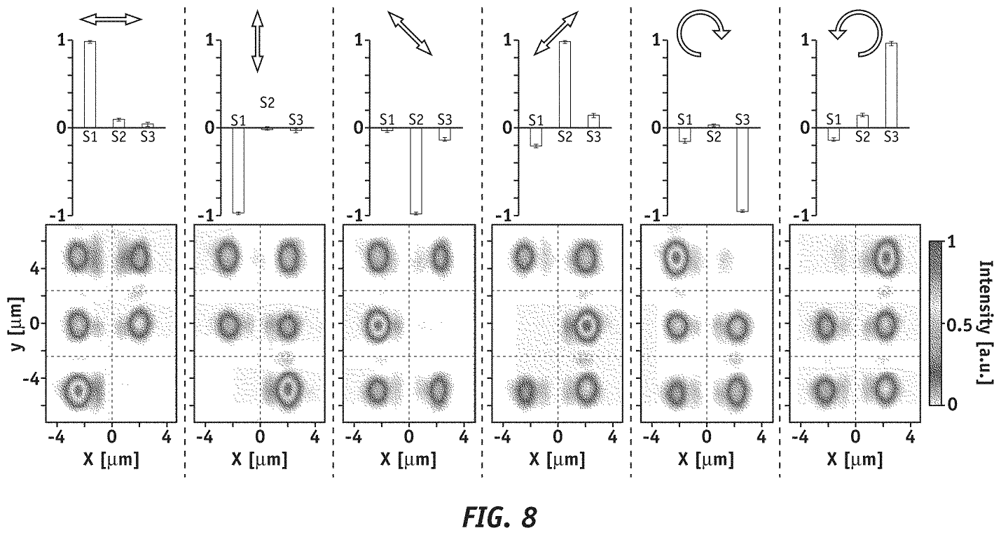

To characterize the metasurface mask, it was illuminated with light from an 850-nm LED (filtered by a 10-nm bandpass filter) with different states of polarization, and the plane corresponding to the image sensor location was imaged using a custom-built microscope. FIG. 8 shows the superpixel characterization results. The measured Stokes parameters are shown on the top for different input polarizations, showing results very close to ideal with low cross talk (<10%) between polarizations and high similarity between different superpixels. The measurements were averaged over more than 120 superpixels (limited by the field of view of the microscope), and the standard deviations are shown in the graph as error bars. In addition, the intensity distribution over a sample superpixel area is shown in FIG. 8 bottom for the same input polarizations. The graphs show the clear ability of the metasurface mask to route light as desired for various input polarizations.

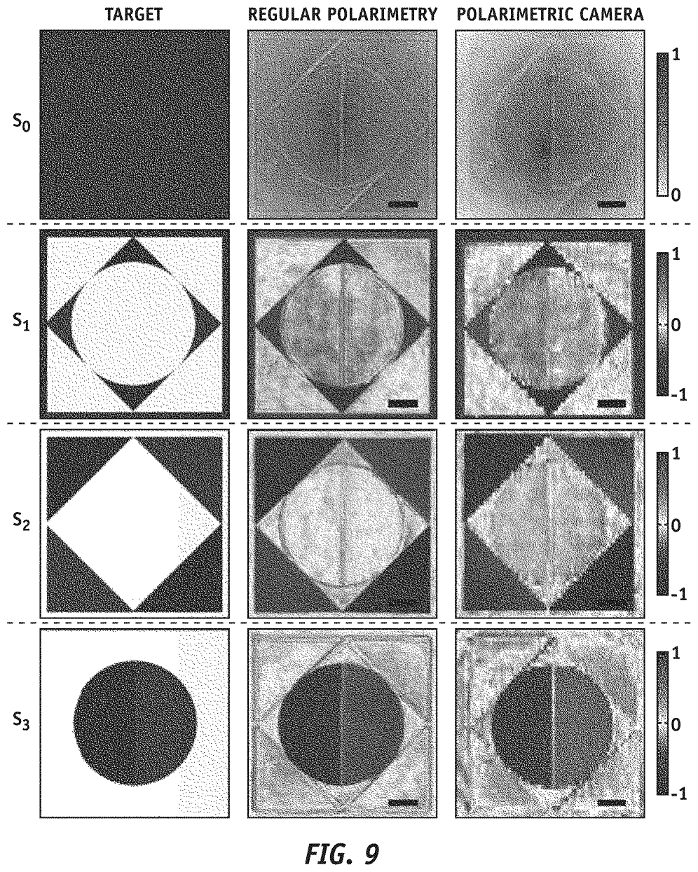

Using the DoFP metasurface mask described above, one could perform polarimetric imaging. To do this, a metasurface polarization mask (using the polarization-phase control method described above was fabricated. Such mask is configured to convert x-polarized input light to an output polarization state characterized by the Stokes parameters shown in the left column of FIG. 8 (Target). Each Stokes parameter is +1 or −1 in an area of the image corresponding to the specific polarization (e.g., S3 being +1 in the right half circle and −1 in the left half circle and 0 elsewhere). Using a second custom-built microscope, the image of the polarization mask was projected to the location of the DoFP mask. First, the metasurface mask was removed and a conventional polarimetric imaging of the projected image using a linear polarizer (LP) and a QWP was performed. The results are plotted in FIG. 9 center (Regular Polarimetry). Second, the LP and QWP were removed, and the DoFP mask was inserted in its place.

A single image was captured of the sensor-location plane in front of the DoFP mask, and the Stokes parameters were extracted from that single image. The results are shown in FIG. 8 right, and are in very good agreement with the results of regular polarimetric imaging. The lower quality of the metasurface polarimetric camera image is mainly due to the limited number of superpixels that fit inside a single field of view of the microscope (limited by the microscope magnification and image sensor size, ˜22× and −15 mm, respectively). This results in a low resolution of 70-by-46 points for the metasurface polarimetric image versus the ˜2000-by-2000 point resolution of the regular polarimetry results. In addition, to form the final image, we need to know the coordinates of each superpixel a priori.

The existing errors in estimating these coordinates (resulting from small tilts in the setup, aberrations of the custom-built microscope, etc.) cause a degraded performance over some superpixels. In a polarization camera made using the metasurface DoFP mask, both of these issues will be solved as the resolution can be much higher, and the mask and the image sensor are lithographically aligned. To extract the polarization information of the image, the intensity was integrated inside the area of two adjacent image sensor pixels, and the corresponding Stokes parameter were simply calculated by dividing their difference by their sum. While straightforward, this is not the optimal method to perform this task as there is non-negligible cross-talk between different polarization intensities measured by the pixels (FIGS. 3A, 3B). The issue becomes more important as one moves toward smaller pixel sizes.

To address the above-mentioned issue, a better polarization data extraction method is to form a matrix that relates the actual intensity of different input polarizations to the corresponding measured values for a specific DoFP metasurface mask design. This allows one to reduce the effect of the cross-talk and measure the polarization state more precisely. The designed small distance between the metasurface and the image sensor (e.g., 9.6 μm for the 4.8-μm pixel) results in a diffraction-limited bandwidth of about 40%. Therefore, the actual bandwidth of the device is limited by the focusing and polarization control efficiencies that drop with detuning from the design wavelength. In addition, it is expected that the same level of performance achieved from the 2.4-μm pixel in this work, can be achieved from a ˜1.7-μm pixel if the material between the mask and the image sensor has a refractive index of 1.5, which is the case when the DoFP mask is separated from the image sensor by an oxide or polymer layer, as in a realistic device.

1. A metasurface-based electromagnetic wave splitting device comprising:
a substrate, and
an array of nano-posts on the substrate, the nano-posts having C₂-symmetric shapes; wherein:
the nano-posts are configured to split an incident electromagnetic wave into a plurality of polarization bases and to focus the split incident electromagnetic wave onto a plurality of target areas according to the plurality of polarization bases.

2. The device of claim 1, wherein dimensions of the nano-posts, orientations of the nano-posts, and distances between adjacent nano-posts are selected according to the polarization bases.

3. The device of claim 2, wherein each polarization base consists of two vertical polarization states.

4. The device of claim 3, wherein the plurality of target areas comprises a superpixel of an image sensor, the superpixel comprising pairs of adjacent pixels.

5. The device of claim 4, wherein each pixel of a pair of adjacent pixels measures a power of one of the two vertical polarization states of a corresponding polarization base.

6. The device of claim 5, wherein the plurality of polarization bases comprises a first, a second and a third polarization base.

7. The device of claim 6, wherein:
the first polarization base comprises a horizontal and a vertical polarization state;
the second polarization base comprises ±45° linear polarization states, and
the third polarization base comprises a right-hand-circular and a left-hand-circular polarization state.

8. The device of claim 1, wherein the nano-posts are elliptical, rectangular or rhomboidal.

9. The device of claim 1, wherein the nano-posts have a higher refractive index than the substrate.

10. The device of claim 8, wherein the nano-posts comprise α-Si and the substrate is a made of glass.

11. The device of claim 1, wherein the array of nano-posts is arranged based on lattice constants within a range ½ operational wavelength +/−30%.

12. A polarization camera comprising the device of claim 7.

13. An imaging method comprising:
providing an array of nano-posts resting on a substrate;
providing an image sensor including a superpixel, and
applying light to the array of nano-posts,
wherein dimensions of the nano-posts, orientations of the nano-posts, and distances between adjacent nano-posts are configured to:
scatter the light off the array of nano-posts;
split the light into a plurality of polarization bases, and
focus the light onto pixels of the superpixel according to the plurality of polarization bases.

14. The imaging method of claim 13, wherein the dimensions of the nano-posts, the orientations of the nano-posts, and the distances between adjacent nano-posts are selected according to the polarization bases.

15. The imaging method of claim 14, wherein:
each polarization base comprises two polarization states;
the superpixel is divided into pairs of adjacent pixels; and
each pixel of a pair of pixels is used to measure a power of one of the two vertical polarization states of the a corresponding polarization base.

16. The imaging method of claim 15, wherein the plurality of polarization bases comprises a first, a second and a third polarization base.

17. The method of claim 16, wherein:
the first polarization base comprises a horizontal and a vertical polarization state;
the second polarization base comprises ±45° linear polarization states, and
the third polarization base comprises a right-hand-circular and a left-hand-circular polarization state.

18. The imaging method of claim 13, wherein the nano-posts are elliptical, rectangular or rhomboidal.

19. The imaging method of claim 13, wherein the nano-posts have a higher refractive index than the substrate.

20. The imaging method of claim 13, wherein the nano-posts comprise α-Si and the substrate is a made of glass.

21. The method of claim 13 implemented in a polarization camera.
